(19) United States
(12) Patent Application Publication
(10) Pub. No.: US 2025/0050485 A1
(43) Pub. Date: Feb. 13, 2025

(54) METHOD FOR AN ELECTRIC NAIL GUN TO DRIVE THE FLYWHEEL TO TRANSMIT NAILING ENERGY

(71) Applicant: DE POAN PNEUMATIC CORP., NEW TAIPEI CITY (TW)

(72) Inventors: CHIA-SHENG LIANG, NEW TAIPEI CITY (TW); I-TSUNG WU, NEW TAIPEI CITY (TW); YU-CHE LIN, NEW TAIPEI CITY (TW); WEN-CHIN CHEN, NEW TAIPEI CITY (TW)

(21) Appl. No.: 18/787,972

(22) Filed: Jul. 29, 2024

(30) Foreign Application Priority Data
Aug. 9, 2023 (TW) 112129991

(51) Int. Cl. B25C 1/06; B25C 1/00; H01F 7/06; H01F 7/20

(52) U.S. Cl. CPC B25C 1/06; H01F 7/064; H01F 7/20; B25C 1/008

(57) ABSTRACT

A method for an electric nail gun to drive the flywheel to transmit nailing energy, including boosting a start voltage of a battery so as to excite an electromagnet to work and then drive the flywheel loaded with nailing energy in a frictional manner to drive a nailing rod to hit the nail. Specifically, the start voltage is boosted by a voltage boost circuit and stored, and the start voltage can release electric charge to constantly excite the electromagnet to work until completion of the nailing action. Based on the present invention, the nailing quality of the electric nail gun can be enhanced.

### BACKGROUND OF INVENTION

### 1. Field of the Invention

The present invention relates generally to the technique of using an electromagnet to drive the flywheel to move in an electric nail gun, and more particularly to a method for an electric nail gun to drive the flywheel to transmit nailing energy.

### 2. Description of Related Art

Different from pneumatic nail guns, electric nail guns use the battery disposed on the gun body to provide DC electric power to drive the electric motor to generate rotational energy, and use an energy conversion mechanism to output sufficient kinetic energy for the nailing rod to move down and hit the nail.

As disclosed in such U.S. Pat. Nos. 7,575,142B2, 7,575,141B, and 8,991,675B2, the conventional technique for electric nail guns includes a plurality of structural details such as an energy conversion mechanism configured inside the body of the electric nail gun. The energy conversion mechanism mainly comprises a flywheel clutch structure.

Specifically, a flywheel is used to accumulate rotational energy generated by the electric motor, and an electromagnet (also called electromagnetic driver) is used to drive the flywheel with accumulated rotational energy to move (include swing) from an idle position to a drive position to actuate the nailing rod in a frictional manner, so as to immediately cause the nailing rod to generate powerful linear nailing energy to hit the nail and implant the nail into the work piece. After nailing, the flywheel is released from the state of frictional drive and the nailing rod can be reset.

The above-mentioned sequential process from the flywheel moving from the idle position to the drive position to driving the nailing rod to complete the nailing action takes a required time period for nailing. As we know, during the required time period for nailing, the nail gun relies on the battery to supply voltage (V) to excite the electromagnet to work. “To work” means the electromagnet excited by the voltage can generate magnetic motive force through the electromagnetic induction generated by the electric current provided by the supply voltage, so as to drive a push shaft to move and constantly apply an acting force (F) to push or pull the flywheel to move (include swing), so that the flywheel can constantly drive the nailing rod in a frictional manner within the required time period for nailing, until completion of the nailing action. “Constantly apply” means the acting force (F) must be maintained within the required time period for nailing, so that, within the required time period for nailing, the acting force (F) can constantly act on the flywheel to actuate the nailing rod in a frictional manner until completion of the nailing action in an ideal and defect-free manner.

As can be seen from the above, the performance of the battery to quickly discharge electric power and to continuously supply necessary voltage (V) to excite the electromagnet within the required time period for nailing is critical for constant delivery of ideal nailing quality by the electric nail gun. However, a battery that can supply high voltage is usually of a big size. For the design of an electric nail gun, the burden of the user's hand during long-term operation must be considered. Therefore, it is inadvisable to use an oversized or overly heavy battery for high voltage. In the current market, the electric nail guns are mostly equipped with lithium batteries that can supply electric voltage of 18 (V). When fully charged, the voltage is around 20.4 (V), but during use, the voltage will be gradually reduced. When the voltage is reduced to 17 (V), the capacity of the battery to release electric charge will be lowered and the nail gun will be unable to stably shoot nails of a length of 90 mm or so perfectly into wooden work pieces. Especially, when the work piece to be nailed is hard and the resistance against the nail is high, the electric nail gun is unlikely to maintain good nailing quality during continuous nailing operations.

Further, in the technical field of electric nail guns, Patent US20230182276A1 filed by the inventor of the present invention has disclosed a technique to use a voltage boost circuit to boost the supply voltage of the DC battery. However, the voltage boost circuit is to drive the electric motor disposed on the electric nail gun, so as to generate rotational energy to drive the nailing rod to hit the nail. The object to be driven by the voltage boost circuit is not the electromagnet disposed on the electric nail gun. Therefore, it is impossible to anticipate the limitations and requirements for continuous supply of a high voltage during the aforesaid required time period for nailing to excite the electromagnet to work to complete the nailing action. For this reason, it is not an existing technique that can be easily converted and applied to the present invention. In other words, until now, there is not any technique in the existing electric nail guns to boost voltage and continuously excite the electromagnet to work. As a result, the existing electric nail guns are limited by the size of nails and the nailing quality can be easily affected. Hence, there is a demand for improvements.

### SUMMARY OF THE INVENTION

In view of the technique problem in the aforesaid prior art, the inventor of the present invention carried out extensive research to expand the range of nail sizes that the electric nail guns can handle, and also to enhance nailing quality of the electric nail guns. Especially, the inventor of the present invention clearly knows that the electric charge quickly released from the capacitors in the voltage boost circuit can excite the electromagnet to work.

In addition, the inventor of the present invention also knows that the magnitude of current to excite the electromagnet can change the magnetic flux density (B) of the magnetic field generated by the electromagnet. When the battery mounted on the electric nail gun supplies a low voltage, the magnetic flux density (B) will relatively decline to affect the acting force of the flywheel to actuate the nailing rod in a frictional manner and consequently affect the nailing quality.

Further, based on Ohm's law (V=IR), when the resistance value (R) of the electromagnet is constant, a higher standing voltage (V) of the battery can generate a larger current (I) to excite the electromagnet, and higher quantity of electric charge (q) moving per unit of time. Thus, through the specific magnetic field (B) generated by the electromagnet, the electromagnet will drive its push shaft to output a larger acting force (F). As can be seen, the performance of the battery equipped on the electric nail gun to constantly supply necessary and sufficient voltage (V) is critical for effective maintenance of the acting force (F) output by the push shaft under the drive of the electromagnet within the required time period for nailing.

On the basis of the above law and principle, the inventor of the present invention carried out numerous experiments and technical improvements, and finally developed a method for an electric nail gun to drive the flywheel to transmit nailing energy, comprising using a battery to supply electricity to excite an electromagnet to work, and drive the flywheel loaded with nailing energy in a frictional manner to drive a nailing rod to hit the nail, so as to overcome the technical problem existing in the prior art.

In the first preferred embodiment, the battery uses a voltage boost circuit to boost and store a start voltage, the electromagnet receives and is excited by the electric charge released from the start voltage to work and drive the nailing rod to complete the nailing action. In addition, when the electromagnet to works, it generates an acting force. The start voltage is specially used to excite the electromagnet to generate the acting force so as to drive the flywheel to firstly touch and press the nailing rod and then drive the nailing rod to complete the nailing action. Further, the voltage boost circuit in the present embodiment can generate a reserve voltage after the nail is implanted into the work piece and before start of the movement of the flywheel.

In the second preferred embodiment, the electromagnet receives a start voltage and is excited to work. The start voltage includes a standing voltage and a reserve voltage that is larger than the standing voltage. The standing voltage supplied by the battery firstly excites the electromagnet to work, the reserve voltage is generated after the standing voltage is boosted by a voltage boost circuit connected to the battery. The reserve voltage releases electric charge and continuously excites the electromagnet to work until completion of the nailing action. Further, in the present embodiment, the acting force generated when the electromagnet to works include the acting force generated by the electromagnet when it is firstly excited by the standing voltage to drive the flywheel to touch and press the nailing rod and the acting force constantly applied by the electromagnet under subsequent excitement of the reserve voltage to drive the flywheel to actuate the nailing rod in a frictional manner until completion of the nailing action. Based on this, the time point for the reserve voltage to release electric charge can be set at the termination of the movement time of the flywheel, and the voltage boost circuit can generate the reserve voltage after the nail is implanted into the work piece and before start of the flywheel movement period.

The above two embodiments further include the following:

The work of the electromagnet will totally take a required time period for nailing. Sequentially, the required time period for nailing includes a flywheel movement period, a period for the nailing rod to push the nail, and a period for the nail to be implanted into the work piece. More specifically, in the first embodiment, during the process from the start of the flywheel movement period until the end of the period for the nail to be implanted into the work piece, the reserve voltage constantly releases electric charge to excite the electromagnet to generate the acting force, so as to drive the flywheel to firstly contact and press the nailing rod and then drive the nailing rod in a frictional manner until completion of the nailing action. In the second embodiment, the standing voltage firstly excites the electromagnet during the flywheel movement period to generate the acting force to drive the flywheel to contact and press the nailing rod, then the reserve voltage releases electric charge to excite the electromagnet during the process from the start of the period for the nailing rod to push the nail until the end of the period for the nail to be implanted into the work piece to constantly apply the acting force so as to drive the flywheel to actuate the nailing rod in a frictional manner until completion of the nailing action.

Further, the aforementioned voltages to excite the electromagnet to work can both be started by a safe drive mechanism of the electric nail gun to excite the electromagnet to work. The safe drive mechanism can be actuated by firstly pressing a slider switch and then pressing a trigger switch, or by firstly pressing the trigger switch and then pressing the slider switch.

Moreover, the above two embodiments further include the following:

The acting force satisfies the following equation:

$$F 1 = \frac{{( NI )}^{2} {μ}_{0}}{2 {δ}^{2}} S$$

where F1 is the acting force required for push shaft of the electromagnet to work, N is the coil turn number of the electromagnet, I is the current generated by the start voltage, μ₀ is the vacuum permeability, δ is the air-gap clearance of the core of the electromagnet, S is the cross sectional area of the magnetic circuit of the electromagnet.

During the required time period for nailing, the start voltage satisfies the following equation

$$I = \frac{V}{R} ( 1 - {e}^{\frac{- RT}{L}} )$$

where V is the start voltage to excite the electromagnet, R is the specific resistance value of the electromagnet, I is the current generated by the start voltage, e is the base of natural logarithm, T is the required time period for nailing, L is the inductance generated by the electromagnet.

The aforementioned voltage boost circuit can be implemented in a design wherein a MOSFET is controlled to turn on/off an inductive circuit, and an inductor in the inductive circuit generates opposing electromotive force upon momentary circuit break to boost the standing voltage and to continuously store and accumulate electricity in an energy storage element to form the aforementioned reserve voltage. In addition, the voltage boost circuit can also be implemented as a voltage multiplying circuit with electric connection of at least one group of charging/discharging capacitors.

Based on the aforementioned implementations, the present invention can increase the acting force (F) generated by the work of the electromagnet without increasing the capacity of the battery, so as to effectively expand the range of nail sizes that can be handled by the electric nail gun, and to enhance the nailing quality of the electric nail gun.

Further benefits and advantages of the present invention will become apparent after a careful reading of the detailed description with appropriate reference to the accompanying drawings.

### BRIEF DESCRIPTION OF THE DRAWINGS

FIG. 1 is a sectional view of a preferred embodiment of the electric nail gun according to the present invention.

FIG. 2 is a configuration view of the first embodiment of the control circuit implementing the driving method of the present invention, depicting a voltage boost circuit in the control circuit to release a reserve voltage to excite the electromagnet to work.

FIG. 3 is a configuration view of the second embodiment of the control circuit implementing the driving method of the present invention, depicting the control circuit with further inclusion of a standing voltage supplied by the battery to excite the electromagnet to work apart from what is depicted in FIG. 2.

FIG. 4 is a diagram of current curves of the present invention, depicting a comparison of multiple curves of the currents to excite the electromagnet to work during the required time period for nailing.

FIG. 5 is a dynamic view of FIG. 1, including FIG. 5(a) to FIG. 5(d), which depict the sequential transmission between the electromagnet, the flywheel, the nailing rod and the nail depicted in FIG. 4 during the required time period for nailing.

### DETAILED DESCRIPTION OF THE INVENTION

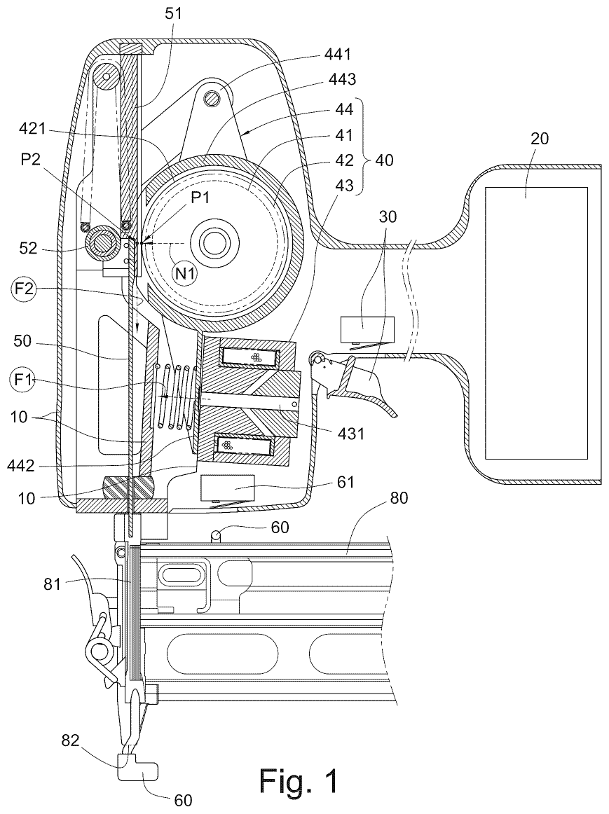

For better understanding of the method disclosed in the present invention for an electric nail gun to drive the flywheel to transmit nailing energy, detailed descriptions are provided below. First, please refer to FIG. 1, which shows an electric nail gun in which the present invention can be embodied. The components disposed in the gun body 10 of the electric nail gun include a battery 20, a trigger switch 30, a safe slider 60, a slider switch 61, an energy conversion mechanism 40, and a nailing rod 50.

The energy conversion mechanism 40 comprises a rotary actuator 41 configured on a swing arm 44, a flywheel 42 that is actuated by the rotary actuator 41 to rotate and accumulate rotational energy, and an electromagnet 43 (also called electromagnetic driver) to drive the flywheel 42 to move (include swing). The two ends of the swing arm 44 are respectively formed with a pivot part 441 and a force applying part 442, and a housing seat 443 is formed on the swing arm 44 between the pivot part 441 and the force applying part 442. The swing arm 44 is pivoted on the gun body 10 through the pivot part 441. The rotary actuator 41 can be axially connected to the flywheel 42 to join together and be mounted inside the housing seat 443. The main body of the electromagnet 43 is fixed on the machine body 10 in an arrangement that a push shaft 431 inside the electromagnet 43 to be driven by magnetic induction is adjacent to and can push and release the force applying part 442. When the electromagnet 43 drives the push shaft 431 to extend outward and push the force applying part 442, the swing arm 44 can be actuated to swing and drive the flywheel 42 to transmit its rotational energy to the nailing rod 50 through frictional drive and generate linear nailing energy (to be detailed later).

Technical details of the energy conversion mechanism 40 depicted in the aforementioned FIG. 1 are disclosed in the such patents as TWI 349601 and U.S. Pat. No. 7,575,142B2 that are already published. The present invention only provides one embodiment with the statement that the flywheel can be driven by the electromagnet to move so as to transmit rotational energy to the nailing rod to generate linear nailing energy. It is therefore to be understood that the present invention is not limited by the configuration of the swing arm or any other equivalent structures that are already disclosed.

Below are descriptions of two embodiments of the control circuit that are used by the driving method of the present invention:

### The First Embodiment of the Control Circuit

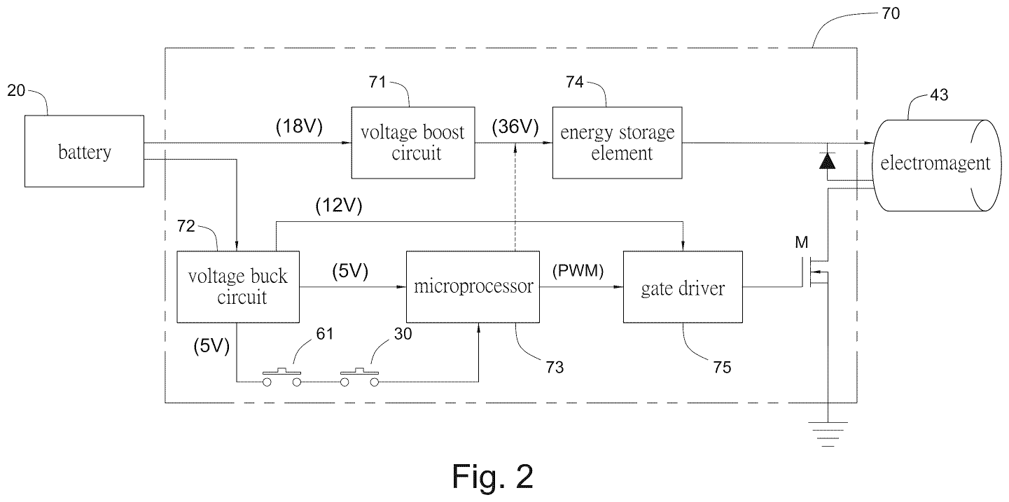

Please refer to FIG. 2, which shows the embodiment comprises a battery 20, which is a Lithium battery that can supply DC voltage, and which is electrically connected to a control circuit 70 configured on the gun body 10, the trigger switch 30, the slider switch 61, the rotary actuator 41 (not shown in FIG. 2), and the electromagnet 43. When nailing, the safe slider 60 can touch and press the work piece to trigger the slider switch 61 to electrify the control circuit 70. The trigger switch 30 can be pressed by the user's hand to electrify the control circuit 70. When both the slider switch 61 and the trigger switch 30 are actuated, a command is sent to the control circuit 70 to excite the electromagnet 43 to work.

In such a disposition, “excite the electromagnet 43 to work” means the electromagnet 43 receives a start voltage and is excited to generate a magnetic motive force, so as to drive the push shaft 431 to move, and the moving push shaft 431 can generate an acting force (F1) to constantly act on the swing arm 44, so that the swing arm 44 can actuate the flywheel 42 to move in a rotational manner. The flywheel 42 with accumulated rotational energy can move from an idle position P1 to a drive position P2, touching, pressing, and driving the nailing rod in a frictional manner 50.

It is to be understood that the swing arm 44 shown in FIG. 1 is only used to prove a possible embodiment in which the flywheel 42 can move from the idle position P1 to the drive position P2. Apart from this, other means of implementation, for example, the flywheel accumulated and stored with rotational energy is disposed on a slide seat, a slide platform, or a slide block other than a swing object and can receive the acting force (F1) and be pushed, pulled, or towed to move from the idle position P1 to the drive position P2 are all covered by the scope of the present invention.

“Frictional drive” means the acting force (F1) generated by the push shaft 431 of the electromagnet 43 can generate a torque on the flywheel 42 through actuation by the swing arm 44, which is transformed to a normal force (N1) generated on the wheel surface 421 of the flywheel 42. Through the normal force (N1), the flywheel 42 at the drive position P2 can constantly touch and press a slide seat 51 formed on the end part of the nailing rod 50. A free roller 52 is provided on the end opposite to the drive position P2 for contact by the slide seat 51 in a sliding manner, so that the normal force (N1) applied by the flywheel 42 at the drive position P2 upon the slide seat 51 can receive a counter-resistance from the free roller 52 and be fully applied upon the slide seat 51, so that a frictional force F2 can be generated between the wheel surface 421 and the slide seat 51 (F2=N1×μ; N1 is normal force, is frictional coefficient). As a result, through the frictional force F2, the rotational energy of the flywheel 42 can be sufficiently transmitted to the nailing rod 50 to generate linear nailing energy. In Particular, the acting force (F1) satisfies the following equation (1):

$$F 1 = \frac{{( NI )}^{2} {μ}_{0}}{2 {δ}^{2}} S \qquad Equation ( 1 )$$

where F1 is the acting force needed for the push shaft of the electromagnet to work, N is the coil turn number of the electromagnet, I is the current generated by the start voltage, μ₀ is vacuum permeability, δ is the air-gap clearance of the core of the electromagnet, and S is the cross sectional area of the magnetic circuit of the electromagnet.

From the above, it can be known that, based on the principle of electromagnetic induction, the electromagnet 43 can drive the push shaft 431 to move and generate an acting force (F1), and a stronger acting force (F1) will produce a stronger normal force (N1) to push the flywheel 42 to swing or move from the idle position P1 to the drive position P2. Through the lever magnifying mechanism, the normal force (N1) is a multiple of the acting force (F) to actuate the nailing rod in a frictional manner 50 to generate linear nailing energy to complete the nailing action.

In addition, the period when the flywheel 42 moves from the idle position P1 to the drive position P2 and then drive the nailing rod in a frictional manner 50 to complete the nailing action, i.e., the work time of the electromagnet 43 totally takes a required time period for nailing (T). As we know, the acting force (F1) generated by the push shaft 431 of the electromagnet 43 must maintain a sufficient strength or even be strengthened during the required time period for nailing (T) so that the flywheel 42 with accumulated and stored rotational energy can have sufficient frictional force (F2) during the required time period for nailing (T) to drive the nailing rod 50 to generate linear nailing energy.

Based on the above, the technical feature of the present invention lies in an improved design of the control circuit 70 disposed on the gun body 10, in which, the control circuit 70 comprises a voltage boost circuit 71 electrically connected between the battery 20, the trigger switch 30, the slider switch 61, and the electromagnet 43, and because the capacitor configured on the voltage boost circuit 71 can instantly release electric charge, during the required time period for nailing (T), it will release electric charge to excite the electromagnet 43 to maintain or strengthen the generated acting force (F1).

Please refer to FIG. 2, which discloses the structural configuration of the first control circuit of the present invention mounted with a voltage boost circuit. As depicted, the whole control circuit 70 comprises the voltage boost circuit 71 electrically connected between the battery 20 and the electromagnet 43, a voltage buck circuit 72, a microprocessor 73 (MCU), an energy storage element 74, and a gate driver 75, wherein:

The battery 20 is not electrically connected to the electromagnet 43 directly to supply the start voltage. Further, the battery 20 firstly supplies a 18 (V) standing voltage to the voltage boost circuit 71 and the voltage buck circuit 72. The 18 (V) standing voltage will decline along with the loss of electric energy during the nailing operation of the electric nail gun. Generally speaking, based on the empiric value, when the standing voltage declines from 18 (V) to 17 (V), the rotational energy of the flywheel 42 at the drive position P2 to drive the nailing rod 50 in a frictional manner will not be effectively converted to the linear nailing energy of the nailing rod 50. As a result, the rate of nailing quality will decline substantially, i.e., the defect rate will increase considerably. This is the existing technical problem that the present invention is seeking to overcome.

One implementation of the voltage boost circuit 71 is to control a MOSFET to switch on/off the inductive circuit. Through the opposing electromotive force generated by the inductance upon momentary break of circuit, the 17 (V)˜18 (V) standing voltage supplied by the battery 20 can be boosted, and be continuously accumulated and stored in the energy storage element 74 to form the 34 (V)˜36 (V) reserve voltage.

Another implementation is to structure the voltage boost circuit 71 with a conventional voltage multiplying circuit. According to common knowledge, the voltage multiplying circuit can be formed by serial or parallel connection of a plurality of capacitors (i.e., the energy storage element 74). Specifically, a plurality of the capacitors can be connected in a serial or parallel arrangement for alternating charge and discharge. More specifically, they are in parallel connection during the charging process, and in serial connection during the discharging process. The alternating serial and parallel connections can be realized through proper arrangement and time control of the operation of the plurality of MOSFETs. Therefore, it is to be understood that the present invention can adopt this existing technology to boost the 17 (V)˜18 (V) standing voltage supplied by the battery 20 to form the 34 (V)˜36 (V) reserve voltage, which can be stored in the plurality of capacitors (i.e., energy storage element 74) to release electric charge at the right time to excite the electromagnet 43.

The energy storage element 74 in the aforementioned voltage boost circuit 71 can be made of high-capacity electrolytic capacitors. The voltage boost circuit 71 is connected to the electromagnet 43 via the energy storage element 74. Under normal circumstances, the 18 (V) standing voltage supplied by the battery 20 can be doubled through the boosting by the voltage boost circuit 71 (i.e., 36V), so that the energy storage element 74 can store the reserve voltage up to 36 (V). Once the 18 (V) standing voltage supplied by the battery 20 to excite the electromagnet 43 declines to 17 (V) or nearly 17 (V), the voltage boost circuit 71 will immediately boost and double the reserve voltage (i.e., 34V). The energy storage element 74 with accumulated and stored reserve voltage of 34 (V) can instantly release electric charge to drive the electromagnet 43 to work continuously, so that the flywheel 42 at the drive position P2 with accumulated rotational energy can effectively and continuously drive the nailing rod 50 in a frictional manner to generate linear nailing energy, thus enhance the nailing quality.

In the voltage buck circuit 72, a conventional device such as a MOSFET switch can be used for time partition, and the smoothing means of inductors and capacitors can be used to decrease the required DC voltage, so that the voltage buck circuit 72 can lower the 18 (V) standing voltage supplied by the battery 20 to two kinds of micro-control voltages: 5 (V) and 12 (V). Specifically, the 5 (V) micro-control voltage is used to start the microprocessor 73 and to electrically connect the trigger switch 30 and the slider switch 61, whereas the 12 (V) micro-control voltage is used to start the gate driver 75.

More specifically, the gate driver 75 is electrically connected between the microprocessor 73 and an IGBT (M), and the IGBT (M) is electrically connected between the electromagnet 43 and the earth wire. Through the 5 (V) micro-control voltage, the trigger switch 30 and the slider switch 61 are electrically connected between the voltage buck circuit 72 and the microprocessor 73, so as to control the operating time of the microprocessor 73. The microprocessor 73 is configured with a PWM. When the microprocessor 73 operates, it can excite the PWM to drive the gate driver 75, so as to start the IGBT (M) to connect the electrically conductive path between the energy storage element 74, the electromagnet 43, and the earth wire. Thus, the energy storage element 74 can instantly release the electric charge stored by the reserve voltage, so as to excite the electromagnet 43 to work continuously. In addition, the microprocessor 73 is also used to detect and judge if the reserve voltage transmitted by the voltage boost circuit 71 to the energy storage element 74 meets a preset standard.

On the other hand, for the start voltage used to excite the electromagnet 43, according to the law of V=IR [where V is the start voltage, I is the current generated by the start voltage, and R is the specific resistance value of the electromagnet], a stronger start voltage (V) can produce larger current (I) to excite the electromagnet 43 to work, and the magnetic field generated by the wire coil of the electromagnet 43 is stronger. Therefore, the present invention can improve the problem existing in the existing technique, i.e., when a battery is used to directly supply electricity to excite the electromagnet, the supply voltage of the battery will often decline gradually, causing decreased current (I) and declined magnetic field strength to excite the electromagnet 43 to affect the work time of the electromagnet 43 and the nailing quality. In other words, the present invention can solve the problem that the nailing quality cannot be stably maintained when the standing voltage supplied by the battery 20 is ≤17 (V). By means of boosting the supply voltage of the battery 20, the present invention can ensure sufficient start voltage for the electromagnet 43 to work continuously.

Further, in the present invention, the start voltage (V) used to excite the electromagnet 43 must satisfy the following equation (2) during the required time period for nailing (T):

$$I = \frac{V}{R} ( 1 - {e}^{\frac{- RT}{L}} ) \qquad Equation ( 2 )$$

where V is the start voltage to excite the electromagnet, R is the specific resistance value of the electromagnet, I is the current generated by the start voltage, e is the base of natural logarithm, T is the required time period for nailing, and L is the inductance generated by the electromagnet.

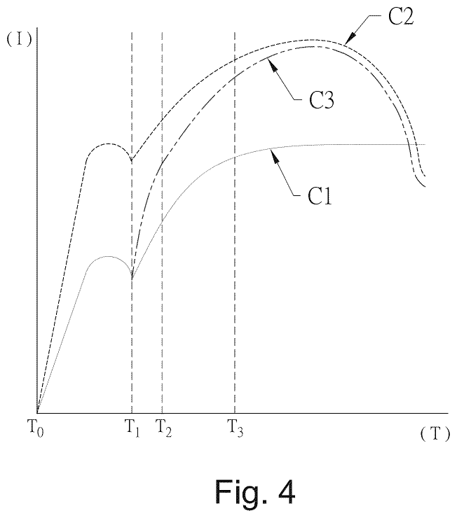

Please refer to FIG. 4, during the required time period for nailing (T), the curves of currents generated by different start voltages to excite the electromagnet to work are depicted, wherein:

The required time period for nailing (T) can be construed as the time period when the aforementioned start voltage (V) [17V<V≤36V] excites the electromagnet 43 to work. According to empirical value, the required time period for nailing (T) of common electric nail guns generally takes 12 μs (microsecond).

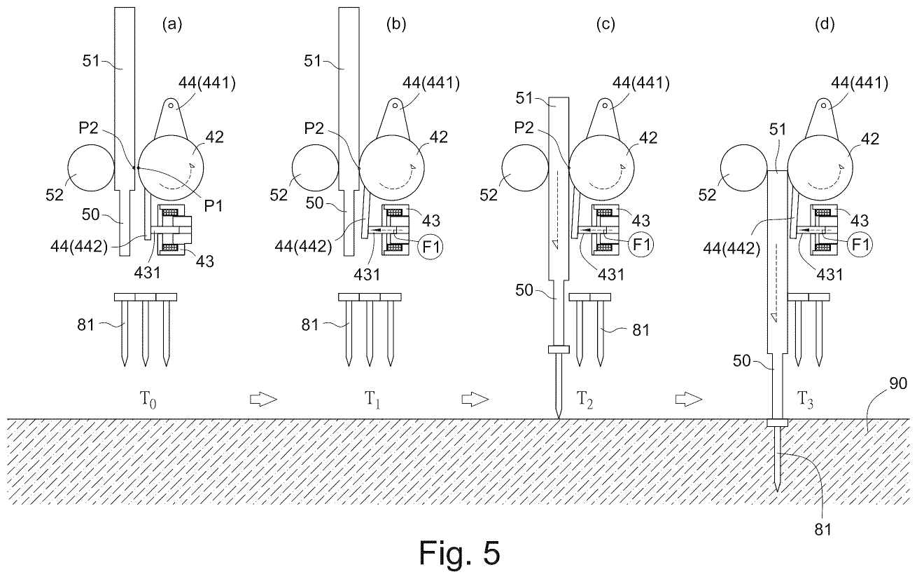

Please refer to FIG. 4 and FIG. 5 collectively. FIG. 5 includes FIG. 5(a) to FIG. 5(d), which sequentially disclose the relative transmission state of the electromagnet 43, the flywheel 42, and the nailing rod 50 during the required time period for nailing (T) depicted in FIG. 4, wherein: TO represents the time point when the flywheel 42 is at the idle position P1, and is indicated by T₀=0 sec; T1 represents the time point when the flywheel 42 has moved to the drive position P2; T2 represents the time point when the nailing rod 50 has completed shooting the nail; T3 represents the time point when the nail has been implanted into the work piece.

Further, the required time period for nailing (T) sequentially includes a flywheel movement period (T0 to T1), a period for the nailing rod to push the nail (T1 to T2), and a period for the nail to be implanted into the work piece (T2 to T3). wherein:

The flywheel movement period (T0 to T1) refers to the time needed for the flywheel 42 to move from the idle position P1 to the drive position P2, i.e., from time point T₀(T₀=0 sec) to time point T₁.

The period for the nailing rod to push the nail (T1 to T2), refers to the time needed for the process in which the flywheel 42 at the drive position P2 (time point T₁) actuates the nailing rod 50 to move linearly downward through frictional drive and then push the nail 81 until its tip end is pressed against the surface of the work piece 90 (i.e., time point T2 when the nail 81 is shot).

The period for the nail to be implanted into the work piece (T2 to T3) refers to the time needed for the process from the point when the tip end of the nail 81 is pressed against the surface of the work piece 90 (i.e., time point T2 when the nail 81 is shot) to the point when the nail 81 is completely implanted into the work piece 90 (i.e., time point T3 when the nail is implanted into the work piece).

Further, from the beginning of the flywheel movement period (T0 to T1), through the period for the nailing rod to push the nail (T1 to T2), and until the end of the period for the nail to be implanted into the work piece (T2 to T3), the start voltage [17 (V)<V≤36(V)] continuously releases electric charge to excite the electromagnet 43 to generate the acting force (F1), so as to drive the flywheel 42 to firstly touch and press the nailing rod 50 and then drive the nailing rod in a frictional manner 50 to complete the nailing action.

### Second Embodiment of the Control Circuit

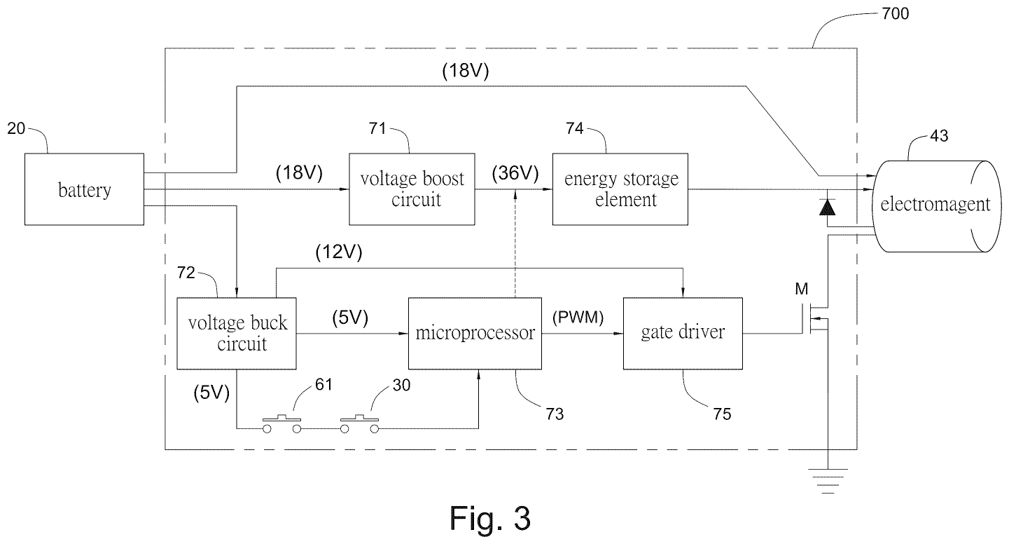

Depicted in FIG. 3 is the configuration architecture of the second embodiment of present invention showing the control circuit 700 with a voltage boost circuit 71. It differs from the first embodiment disclosed in FIG. 2 in that, the control circuit 700 has an additional hot circuit directly connected from the battery 20 to the electromagnet 43. Except this, all other configurations are almost the same. It is to be noted, however, the method used by the second embodiment shown in FIG. 3 to excite the electromagnet to work is substantially different from that of the first embodiment, as described below:

In the present embodiment, the start voltage used to excite the electromagnet 43 to work includes the 17 (V)˜18 (V) standing voltage directly supplied by the battery 20 and the 34 (V)˜36 (V) reserve voltage larger than the standing voltage after the boosting.

In the first embodiment, the 17 (V)˜18 (V) standing voltage is not directly connected to the electromagnet 43. The 34 (V)˜36 (V) reserve voltage is directly called start voltage in the first embodiment. In addition, in the second (the present) embodiment, the 34 (V)˜36 (V) reserve voltage is generated after the voltage boost circuit 71 boosts the 17 (V)˜18 (V) standing voltage, wherein the means of boosting the standing voltage is as described in the first embodiment, and is therefore not repeated herein.

As the electromagnet 43 can receive and be excited by voltages larger than 17 (V) to drive the nailing rod 50 to complete the nailing action, the second (the present) embodiment firstly uses the standing voltage (V>17) supplied by the battery 20 as the start voltage, so as to excite the electromagnet 43 to work first. Then, the 34 (V)˜36 (V) reserve voltage is used to release electric charge to continuously excite the electromagnet 43 to work until the nailing rod 50 completes the nailing action.

Further, the 17 (V)˜18 (V) standing voltage firstly excites the electromagnet 43 to generate the acting force (F1) to drive the flywheel 42 to touch and press the nailing rod 50, then the 34 (V)˜36 (V) reserve voltage excites the electromagnet 43 to constantly apply the acting force (F1), so as to drive the flywheel 42 to actuate the nailing rod in a frictional manner 50 to complete the nailing action.

In the second (the present) embodiment, the acting force (F1) shall satisfy the above Equation (1), and the required time period for nailing (T) shall satisfy the above Equation (2). Specifically, the start voltage to excite the electromagnet (V) must include the standing voltage and the reserve voltage, and the current generated by the start voltage (I) must include the current generated by the standing voltage and the current generated by the reserve voltage.

Please refer to FIG. 4. Three current curves C1, C2, and C3 are provided, wherein:

Current curve C1 indicates conventional application of the start voltage (V) supplied by the battery without boosting. When applied during the period from the aforementioned T0 to T3 time points, [i.e., the required time period for nailing (T)], because of the low voltage due to declination [i.e., V≤17 (V),], the current (I) to excite the electromagnet to work is relatively low and the nailing quality cannot be properly maintained.

Current curve C2 indicates the application of the above embodiment of the first control circuit of the present invention, wherein, during the period from the aforementioned T0 to T3 time points [i.e., the required time period for nailing (T)], when the voltage boost circuit 71 releases the start voltage (V) [i.e., 17(V)<V≤36 (V)], the strength of the current to excite the electromagnet to work is obviously better than the conventional current curve C1.

Current curve C3 indicates the application of the above embodiment of the second control circuit of the present invention, wherein, during the period from the aforementioned T1 to T3 time points [i.e., the period for the nailing rod to push the nail (T1 to T2) plus the period for the nail to be implanted into the work piece (T2 to T3)], the voltage boost circuit 71 releases the aforementioned reserve voltage as the start voltage (V) [i.e., 17(V)<V≤36 (V)], the strength of the current to excite the electromagnet to work is obviously better than the conventional current curve C1. In addition, during the period from the aforementioned T0 to T1 time points (i.e., the flywheel movement period), the 17 (V)˜18 (V) standing voltage supplied by the battery can be used as the start voltage (V), i.e., it can satisfy the requirement for energy conversion to drive the flywheel 42 to move from the idle position P1 to the drive position P2 (except for the movement of the flywheel to drive the nailing rod in a frictional manner to generate linear kinetic energy). Such a design enables alternative supply of electricity by the battery and the voltage boost circuit to excite the electromagnet and can help saving energy.

From the above Equation (2), together with FIG. 4, FIG. 5(a), to FIG. 5(b), we can know that: during the time period from T0 to T1, for the start voltage (V) to excite the electromagnet 43, whether it is immediately boosted by the voltage boost circuit 71 (as shown in the current curve C2 of the first embodiment), or boosted halfway (as shown in the current curve C3 of the second embodiment), or not boosted (as shown in the current curve C1 of conventional battery power supply), the value of the momentary current (I) will be affected by the increase of the inductance of the electromagnet, and will firstly increase and then decrease slightly. Then, during the period from T1 to T2, and from T2 to T3 time points, the curves C2 and C3 of the currents generated by the electric charge released after direct and indirect boosting by the voltage boost circuit 71 show an effect that the current (I) to excite the electromagnet 43 to work can be continuously increased, indicating obviously better performance than the current curve (C1) without boosting.

As indicated, during the period when the flywheel 42 at the drive position P2 actuates the nailing rod 50 to move linearly downward until completion of the nailing action (i.e., the time period from T1 to T3 time points), the application of the voltage boost circuit 71 to release electric charge from the higher reserve voltage (V=34 or 36V) accumulated and stored in advance does maintain or continuously increase the current (I) to excite the electromagnet 43 to work, thus maintaining or strengthening the acting force (F1), so that the flywheel 42 can maintain or increase the frictional force (N) to fully transmit the rotational energy to the nailing rod 50 to generate linear nailing energy.

In other words, the optimal time point to release electric charge from the reserve voltage (V=34 or 36V) stored in the energy storage element 74 is at the end of the flywheel movement period (T0 to T1), and during the process from the start of the period for the nailing rod to push the nail (T1 to T2) to the end of the period for the nail to be implanted into the work piece (T2 to T3), the energy storage element 74 will be continuously releasing electric charge to excite the electromagnet 43 so as to maintain the work of the electromagnet 43 until completion of the nailing action. Through such an implementation, in case of strong resistance against nailing due to a hard work piece to be nailed, or a nail of big size, the nailing quality can be properly maintained.

In the above, after the aforementioned T3 time point and before the T1 time point, the voltage boost circuit 71 can charge the energy storage element 74 in advance to accumulate and store electricity to generate the reserve voltage (V=34 or 36V).

Further, the charge storage capacity of the energy storage element 74 (also called capacitor) must satisfy the following equation (3):

$$C = \frac{V}{Q} \qquad Equation ( 3 )$$

where C is the capacitance value of the energy storage element, V is the voltage to excite the electromagnet, Q is the charge storage capacity of the energy storage element. Further, during the nailing process, in order for the energy storage element 74 to release necessary voltage V to excite the electromagnet, the capacitance value of the energy storage element C must satisfy the charge storage capacity Q until the end of the time period for the nail to be implanted into the work piece (T₂ to T₃).

Further, both the start voltage in the first embodiment depicted in FIG. 2 and the standing voltage in the second embodiment depicted in FIG. 3 can be started by a safe drive mechanism of the electric nail gun to excite the electromagnet 43 to work. The safe drive mechanism can be started by firstly pressing the safe slider 60 (see FIG. 1) against the surface of the work piece to be nailed to press the slider switch 61, and then pressing the trigger switch 30 with a finger. The safe drive mechanism can also be implemented otherwise to be started by firstly pressing the trigger switch 30 and then pressing the slider switch 61 to start the voltage to excite the electromagnet 43 to work.

Although the invention has been explained in relation to its preferred embodiment, it is to be understood that many other possible modifications and variations can be made without departing from the spirit and scope of the invention as hereinafter claimed.

1. A method for an electric nail gun to drive the flywheel to transmit nailing energy, include starting a battery to supply electricity to excite an electromagnet to work and drive the flywheel loaded with nailing energy to drive a nailing rod in a frictional manner to hit the nail; wherein:
the battery uses a voltage boost circuit to boost and store a start voltage, and the electromagnet receives the electric charge released by the start voltage and is excited to work until completion of the nailing action.

2. The method for an electric nail gun to drive the flywheel to transmit nailing energy defined in claim 1, wherein said electromagnet works to generate an acting force, the start voltage is specially used to excite the electromagnet to generate the acting force, so as to drive the flywheel to firstly touch and press the nailing rod, and then to actuate the nailing rod in a frictional manner until completion of the nailing action.

3. The method for an electric nail gun to drive the flywheel to transmit nailing energy defined in claim 2, wherein said acting force satisfies the following equation:
$$F 1 = \frac{{( NI )}^{2} {μ}_{0}}{2 {δ}^{2}} S$$
where F1 is the acting force needed for the push shaft of the electromagnet to work, N is the coil turn number of the electromagnet, I is the current generated by the start voltage, μ0 is vacuum permeability, δ is the air-gap clearance of the core of the electromagnet, and S is the cross sectional area of the magnetic circuit of the electromagnet.

4. The method for an electric nail gun to drive the flywheel to transmit nailing energy defined in claim 2, wherein the work of the electromagnet totally takes a required time period for nailing, the start voltage satisfies the following equation during the required time period for nailing:
$$I = \frac{V}{R} ( 1 - {e}^{\frac{- RT}{L}} )$$
where V is the start voltage to excite the electromagnet, R is the specific resistance value of the electromagnet, I is the current generated by the start voltage, e is the base of natural logarithm, T is the required time period for nailing, and L is the inductance generated by the electromagnet.

5. The method for an electric nail gun to drive the flywheel to transmit nailing energy defined in claim 4, wherein said required time period for nailing sequentially includes a flywheel movement period, a period for the nailing rod to push the nail, and a period for the nail to be implanted into the work piece.

6. The method for an electric nail gun to drive the flywheel to transmit nailing energy defined in claim 5, wherein, from the start of the flywheel movement period until the end of the period for the nail to be implanted into the work piece, the start voltage constantly releases electric charge to excite the electromagnet to generate the acting force, so as to drive the flywheel to firstly touch and press the nailing rod and then drive the nailing rod in a frictional manner until completion of the nailing action.

7. The method for an electric nail gun to drive the flywheel to transmit nailing energy defined in claim 6, wherein, the start voltage is started by a safe drive mechanism of the electric nail gun to excite the electromagnet to work, and the safe drive mechanism is started by firstly touching and pressing a slider switch and then pressing a trigger switch.

8. The method for an electric nail gun to drive the flywheel to transmit nailing energy defined in claim 6, wherein, through the start of a safe drive mechanism of the electric nail gun, the start voltage excites the electromagnet to work, and the safe drive mechanism is started by firstly pressing a trigger switch and then touching and pressing a slider switch.

9. The method for an electric nail gun to drive the flywheel to transmit nailing energy defined in claim 5, wherein said voltage boost circuit generates the start voltage from the end of the period for the nail to be implanted into the work piece until the start of the flywheel movement period.

10. The method for an electric nail gun to drive the flywheel to transmit nailing energy defined in claim 1, wherein said voltage boost circuit includes a MOSFET that can be controlled to turn on/off an inductive circuit, and an inductor in the inductive circuit that is used to generate opposing electromotive force upon momentary circuit break to boost the standing voltage and to continuously store and accumulate electricity in an energy storage element to form a reserve voltage.

11. The method for an electric nail gun to drive the flywheel to transmit nailing energy defined in claim 1, wherein said voltage boost circuit includes a voltage multiplying circuit with electric connection of at least one group of charging/discharging capacitors.

12. A method for an electric nail gun to drive the flywheel to transmit nailing energy, comprising starting a battery to supply electricity to excite an electromagnet to work, and then to drive the flywheel loaded with nailing energy to drive a nailing rod in a frictional manner to hit the nail; wherein:
the electromagnet receives a start voltage and is excited to work, the start voltage includes a standing voltage and a reserve voltage that is larger than the standing voltage, the standing voltage is supplied by the battery to firstly excite the electromagnet to work, the reserve voltage is generated after a voltage boost circuit connected to the battery boosts the standing voltage, and the reserve voltage releases electric charge to continuously excite the electromagnet to work until completion of the nailing action.

13. The method for an electric nail gun to drive the flywheel to transmit nailing energy defined in claim 12, wherein said electromagnet works to generate an acting force, the standing voltage firstly excites the electromagnet to generate the acting force to drive the flywheel to touch and press the nailing rod, and then the reserve voltage excites the electromagnet to constantly apply the acting force, so as to drive the flywheel to actuate the nailing rod in a frictional manner until completion of the nailing action.

14. The method for an electric nail gun to drive the flywheel to transmit nailing energy defined in claim 12, wherein said acting force satisfies the following equation:
$$F 1 = \frac{{( NI )}^{2} {μ}_{0}}{2 {δ}^{2}} S$$
where F1 is the acting force needed for the push shaft of the electromagnet to work, N is the coil turn number of the electromagnet, I is the current generated by the start voltage, μ₀ is vacuum permeability, δ is the air-gap clearance of the core of the electromagnet, and S is the cross sectional area of the magnetic circuit of the electromagnet.

15. The method for an electric nail gun to drive the flywheel to transmit nailing energy defined in claim 12, wherein the work of the electromagnet work totally takes a required time period for nailing, and the start voltage satisfies the following equation during the required time period for nailing:
$$I = \frac{V}{R} ( 1 - {e}^{\frac{- RT}{L}} )$$
where V is the start voltage to excite the electromagnet, R is the specific resistance value of the electromagnet, I is the current generated by the start voltage, e is the base of natural logarithm, T is the required time period for nailing, and L is the inductance generated by the electromagnet.

16. The method for an electric nail gun to drive the flywheel to transmit nailing energy defined in claim 12, wherein said required time period for nailing sequentially includes a flywheel movement period, a period for the nailing rod to push the nail, and a period for the nail to be implanted into the work piece.

17. The method for an electric nail gun to drive the flywheel to transmit nailing energy defined in claim 16, wherein said standing voltage firstly excites the electromagnet to generate the acting force during the flywheel movement period to drive the flywheel to touch and press the nailing rod, and then the reserve voltage releases electric charge to excite the electromagnet to constantly apply the acting force from the start of the period for the nailing rod to push the nail until the end of the period for the nail to be implanted into the work piece, so as to drive the flywheel to actuate the nailing rod in a frictional manner until completion of the nailing action.

18. The method for an electric nail gun to drive the flywheel to transmit nailing energy defined in claim 17, wherein said standing voltage is started by a safe drive mechanism of the electric nail gun to excite the electromagnet to work, and the safe drive mechanism is started by firstly touching and pressing a slider switch and then pressing a trigger switch.

19. The method for an electric nail gun to drive the flywheel to transmit nailing energy defined in claim 17, wherein said standing voltage is started by a safe drive mechanism of the electric nail gun to excite the electromagnet to work, and the safe drive mechanism is started by firstly pressing a trigger switch and then touching and pressing a slider switch.

20. The method for an electric nail gun to drive the flywheel to transmit nailing energy defined in claim 17, wherein the time point for the reserve voltage to release electric charge is at the end of the flywheel movement period.

21. The method for an electric nail gun to drive the flywheel to transmit nailing energy defined in claim 17, wherein said voltage boost circuit generates the reserve voltage from the end of the period for the nail to be implanted into the work piece until the start of the flywheel movement period.

22. The method for an electric nail gun to drive the flywheel to transmit nailing energy defined in claim 12, wherein said voltage boost circuit includes a MOSFET that can be controlled to turn on/off an inductive circuit, and an inductor in the inductive circuit that is used to generate opposing electromotive force upon momentary break of circuit to boost the standing voltage and to continuously store and accumulate electricity in an energy storage element to form the aforementioned reserve voltage.

23. The method for an electric nail gun to drive the flywheel to transmit nailing energy defined in claim 12, wherein said voltage boost circuit includes a voltage multiplying circuit with electric connection of at least one group of charging/discharging capacitors.
